(19) United States
(12) Patent Application Publication
(10) Pub. No.: US 2011/0213491 A1
(43) Pub. Date: Sep. 1, 2011

(54) SYSTEMS AND METHODS FOR MAIL FORWARDING AND SPECIAL HANDLING SERVICES

(75) Inventors: Alfred T. Rundle, JR., Endwell, NY (US); Tonya K. Bender, Owego, NY (US); Linda Harowicz, Owego, NY (US)

(73) Assignee: Lockheed Martin Corporation, Bethesda, MD (US)

(21) Appl. No.: 12/673,958

(22) PCT Filed: Feb. 6, 2008
(86) PCT No.: PCT/US08/53154

§ 371 Date: Sep. 27, 2010

Related U.S. Application Data
(60) Provisional application No. 60/956,612, filed on Aug. 17, 2007.

(51) Int. Cl. B07C 3/00; G06F 7/00

(52) U.S. Cl. 700/215; 700/224

(57) ABSTRACT

Methods and systems for mail forwarding and special handling services are disclosed. The methods and systems can include processing mail in a single pass or in multiple passes (i.e., online or offline). The methods and systems can include one or more of a scannable symbol, an extra appended post code digit, a dedicated database field, separate table indexed by a control number, a logically separate database, or a database hosted on a separate server for use in identifying mail pieces needing special handling and retrieving special handling information, for example forwarding address text for such mail pieces.

### CROSS-REFERENCE TO RELATED APPLICATIONS

This application claims the benefit of U.S. Provisional Application No. 60/956,612, entitled “Software For Automatically Recognizing And Forwarding Mail Sent To A Former Address”, filed Aug. 17, 2007, which is incorporated herein by reference in its entirety.

The present invention generally relates to methods for sorting mail as well as mail processing systems.

Today, many postal systems utilize more or less automatic systems for handling mails. There may be a wide variety of situations where a mail piece may need a special handling service such as forwarding to an address other than the address on the mail piece. For example, the addressee of the mail piece may have moved to a new address, or the addressee may be having his/her mail temporarily forwarded to another address, or the addressee may no longer be at the address and there may be no forwarding address on file. Another situation can arise in which a special code on the mail piece directs the postal system on how the sender of the mail piece would like the mail piece to be handled in certain events (e.g., “do not forward”, “address correction”, or the like).

U.S. Pat. No. 5,422,821 is entitled “Apparatus for intercepting and forwarding incorrectly addressed postal mail.”

In situations where special handling services are requested, there may nevertheless be a demand for an efficient handling in order to be able to provide e.g. short delivery times and a reduced number of mails sent to wrong address. Thus, there may be a need for postal systems which may handle mails in a more efficient way.

In at least one embodiment of the present invention, a postal (i.e., mail piece) forwarding system may detect that a mail piece needs a special handling service, such as forwarding to an alternative address. The embodiment can include processing the mail piece identified as needing special handling and, in the case of forwarding, sorting the mail piece for delivery to a forwarding address.

While it may be most efficient and/or desirable for an embodiment of a system or method to rely solely on automatic processing of mail pieces, it may not be possible in all circumstances. The mail piece may not be in condition for fully automatic processing due to any number of reasons, for example, a poorly handwritten address, a damaged and/or crooked (skewed) addresses, or the like. Therefore, although embodiments of the present invention may be designed to operate using totally automatic address recognition and processing, these embodiments may be adapted to also include manual address recognition and processing.

For example, the system may be arranged to function totally automatically as long as the addresses are recognised in a reliable manner. If an address is not possible to recognise by the system in a reliable manner, an operator may be notified and the address may recognised manually by the operator. This may, for instance, be implemented by calculating a level of reliability for each recognised address and if this level of reliability is below a reference level the operator is notified.

According to one aspect a method for sorting mail is provided. The method may include reading an address on a mail piece during a first sorting operation, assigning a unique identification number to the mail piece, determining if the mail piece is in need of a special handling service, and storing information read from the mail piece and the unique identification number in a database indexed by mail piece identification number, recording a first portion of special handling information in the database without recording an express notation that the mail piece is in need of the special handling service, and recording a second portion of the special handling information in a separate table of the database not indexed by the mail piece identification number; sorting the mail piece to a separate bin, if the mail piece is in need of the special handling service; and in a second sorting operation, different from the first sorting operation, processing mail pieces from the separate bin and retrieving the special handling information corresponding to the mail piece from the database and applying a portion of the special handling information to the mail piece.

The special handling service may be mail forwarding. Further, the special handling information may include forwarding address text.

The method may further comprise storing additional special handling information in a separate database, the separate database not indexed by mail piece identification number.

The second sorting operation may occur on sorting equipment different than that used for the first sorting operation.

According to a second aspect a mail processing system is provided. The mail processing system may include recognizing means for recognizing an address read from a scanned mail piece, means for assigning a unique identification number to the mail piece and for determining if the mail piece is in need of a special handling service, a database for storing information read from the mail piece, the database being indexed by mail piece identification number, and a printer for applying special handling information to the mail piece if needed, recording means for recording special handling information in a separate table of the database not indexed by the mail piece identification number, without an express notation that the mail piece is in need of the special handling service; sorting means for sorting the mail piece to a separate bin, if the mail piece is in need of the special handling service; processing means for processing images from mail pieces in the separate bin, in a second sorting operation, different from the first sorting operation; and retrieving means for retrieving the special handling information corresponding to the mail piece from the database and applying a portion of the special handling information to the mail piece via printing means.

The recognizing means may include accepting input from a video coding operator.

The special handling service may be mail forwarding. The special handling information may include forwarding address text.

According to a third aspect a method for sorting mail during a single sorting pass is provided. The method may include reading an address on a mail piece, assigning a unique identification number to the mail piece, determining if the mail piece is in need of a special handling service, and storing information read from the mail piece and the unique identification number in a database indexed by mail piece identification number, recording special handling information in the database in a record corresponding to the mail piece identification number, without an express notation that the mail piece is in need of the special handling service; and retrieving the special handling information corresponding to the mail piece from the database and applying the special handling information to the mail piece.

The special handling service may be mail forwarding and the special handling information may include forwarding address text.

According to a fourth aspect a mail processing system for sorting mail during a single sorting pass is provided. The system may include recognizing means for recognizing an address read from a scanned mail piece, means for assigning a unique identification number to the mail piece and means for determining if the mail piece is in need of a special handling service, a database for storing information read from the mail piece, the database being indexed by mail piece identification number, and a printer for applying special handling information to the mail piece if needed, recording means for recording special handling information in the database in a record corresponding to the mail piece identification number, without an express notation that the mail piece is in need of the special handling service; and retrieving means for retrieving the special handling information corresponding to the mail piece identification number from the database and applying the special handling information to the mail piece.

The recognizing means may include accepting input from a video coding operator.

The special handling service may be mail forwarding and the special handling information may include forwarding address text.

According to fifth aspect a method for sorting mail is provided. The method may include reading an address on a mail piece during a sorting pass, assigning a unique identification number to the mail piece, determining if the mail piece is in need of a special handling service, storing information read from the mail piece and the unique identification number in a database indexed by mail piece identification number, recording special handling information in the database at the record corresponding to the mail piece identification number, without an express notation that the mail piece is in need of the special handling service; if the mail piece is in need of the special handling service, printing and applying a scannable symbol to the mail piece indicating that the mail piece is in need of the special handling service; and recognizing the scannable symbol on the mail piece and retrieving the special handling information corresponding to the mail piece from the database and applying a portion of the special handling information to the mail piece.

The special handling service may be mail forwarding and the special handling information may include forwarding address text.

The scannable symbol may be a barcode or a modified version of a routing barcode.

The special handling information may be applied to the mail piece during another sorting pass.

According to a sixth aspect a mail processing system is included. The system may include recognizing means for recognizing an address read from a scanned mail piece, means for assigning a unique identification number to the mail piece and means for determining if the mail piece is in need of a special handling service, a database for storing information read from the mail piece, the database being indexed by mail piece identification number, and a printer for applying special handling information to the mail piece if needed, recording means for recording special handling information in the database at the record corresponding to the mail piece identification number, without an express notation that the mail piece is in need of the special handling service; printing means for printing and applying a scannable symbol to the mail piece indicating that the mail piece is in need of the special handling service, if the mail piece is in need of the special handling service; recognizing means for recognizing the scannable symbol on the mail piece and retrieving the special handling information corresponding to the mail piece from the database; and applying means for applying a portion of the special handling information to the mail piece.

The recognizing means may include accepting input from a video coding operator.

The special handling service may be mail forwarding and the special handling information may include forwarding address text.

According to a seventh aspect a method for sorting mail is provided. The method may include reading an address on a mail piece during a first sorting operation, assigning a unique identification number to the mail piece, determining if the mail piece is in need of a special handling service, storing information read from the mail piece and the unique identification number in a database indexed by mail piece identification number, recording special handling information in the database in a dedicated field of a record corresponding to the mail piece identification number, without an express notation that the mail piece is in need of the special handling service; during a second sorting operation, subsequent to the first sorting operation, recognizing the unique identification number on the mail piece and determining if there are any data in the dedicated field; and if there are data in the dedicated field, retrieving the special handling information corresponding to the mail piece from the dedicated field of the database record and applying the special handling information to the mail piece.

The special handling service may be mail forwarding and the special handling information may include forwarding address text.

The step of applying the special handling information to the mail piece may be done during a third sorting operation, the third sorting operation being different from the first sorting operation and the second sorting operation.

According to an eighth aspect a mail processing system is provided. The mail processing system may include recognizing means for recognizing an address read from a scanned mail piece, means for assigning a unique identification number to the mail piece and means for determining if the mail piece is in need of a special handling service, a database for storing information read from the mail piece, the database being indexed by mail piece identification number, and a printer for applying special handling information to the mail piece if needed, recording means for recording special handling information in the database in a dedicated field of a record corresponding to the mail piece identification number, without an express notation that the mail piece is in need of the special handling service; recognizing means for recognizing the unique identification number on the mail piece and determining if there are any data in the dedicated field during a second sorting operation, subsequent to the first sorting operation; and retrieving means for retrieving the special handling information corresponding to the mail piece from the dedicated field of the database record and applying the special handling information to the mail piece, if there are data in the dedicated field.

The recognizing means may include accepting input from a video coding operator.

The special handling service may be mail forwarding and the special handling information includes forwarding address text.

According to a ninth aspect a method for sorting mail is provided. The method may include reading an address on a mail piece during a first sorting operation, assigning a unique identification number to the mail piece, determining if the mail piece is in need of a special handling service, storing information read from the mail piece and the unique identification number in a database indexed by mail piece identification number, appending an extra digit to a post code associated with the mail piece if the mail piece is in need of the special handling service and storing the post code with the appended digit in the database; applying the post code with the appended digit to the mail piece; during a second sorting operation, subsequent to the first sorting operation, recognizing the post code; and if the post code contains an extra digit, retrieving special handling information corresponding to the mail piece and applying the special handling information to the mail piece.

The special handling service may be mail forwarding and the special handling information may include forwarding address text.

The step of applying the special handling information to the mail piece may be done during a third sorting operation, the third sorting operation being different from the first sorting operation and the second sorting operation.

The special handling information may be retrieved from the database in which the post code is stored.

The special handling information may be retrieved from a database different than the database in which the post code is stored.

According to a tenth aspect a mail processing system is provided. The mail processing system may include recognizing means for recognizing an address read from a scanned mail piece, means for assigning a unique identification number to the mail piece and means for determining if the mail piece is in need of a special handling service, a database for storing information read from the mail piece, the database being indexed by mail piece identification number, and a printer for applying special handling information to the mail piece if needed, appending means for appending an extra digit to a post code associated with the mail piece if the mail piece is in need of the special handling service; storing means for storing the post code with the appended digit in the database; applying means for applying the post code with the appended digit to the mail piece; recognizing means for recognizing the post code, during a second sorting operation, subsequent to the first sorting operation; and retrieving means for retrieving special handling information corresponding to the mail piece and applying, via the printing means, the special handling information to the mail piece, if the post code contains an extra digit.

The recognizing means may include accepting input from a video coding operator.

The special handling service may be mail forwarding and the special handling information may include forwarding address text.

According to an eleventh aspect a method for sorting mail is provided. The method may include reading an address on a mail piece during a first sorting operation, assigning a unique identification number to the mail piece, determining if the mail piece is in need of a special handling service, storing information read from the mail piece and the unique identification number in a record of a database indexed by mail piece identification number, the database hosted on a first server and the record corresponding to the unique identification number assigned to the mail piece, storing a delivery post code in the database record; if the special handling service is needed, storing a control number in the record; during a second sorting operation, subsequent to the first sorting operation, recognizing the mail piece identification number on the mail piece; if the record contains a control number, retrieving special handling service information from an extract database hosted on a second server separate from the first server; and applying new delivery information to the mail piece according to the special handling service information.

The special handling service may be mail forwarding and the special handling service information may include forwarding address text.

The post code stored in the database record may be associated with the address read during the first sorting operation.

The post code stored in the database record may be associated with a return address.

The post code stored in the database record may be associated with a forwarding address.

According to a twelfth aspect a mail processing system is provided. The system may include recognizing means for recognizing an address read from a scanned mail piece during a first sorting operation, means for assigning a unique identification number to the mail piece and means for determining if the mail piece is in need of a special handling service, a database for storing information read from the mail piece, the database being hosted on a first server and indexed by mail piece identification number, and a printer for applying special handling information to the mail piece if needed, storing means for storing a delivery post code in the database record, and, if the special handling service is needed, storing a control number in the record; recognizing means for recognizing the mail piece identification number on the mail piece, during a second sorting operation, subsequent to the first sorting operation; retrieving means for retrieving special handling service information from an extract database hosted on a second server separate from the first server, if the record contains a control number; and applying means for applying new delivery information to the mail piece according to the special handling service information.

The recognizing means may include accepting input from a video coding operator.

The special handling service may be mail forwarding and the special handling information may include forwarding address text.

According to a thirteenth aspect a mail processing system is provided. The system may include recognizing means for recognizing an address read from a scanned mail piece, means for assigning a unique identification number to the mail piece and means for determining if the mail piece is in need of a special handling service, a sorting database for storing information read from the mail piece and the unique identification number in a record, the database being indexed by mail piece identification number, and a printer for applying special handling information to the mail piece if the special handling service is needed, the sorting database hosted on a first server and the record corresponding to the unique identification number assigned to the mail piece, first storing means for storing a delivery post code in the sorting database record and, if the special handling service is needed, storing a control number in the sorting database record; second storing means for storing the control number and special handling service information in a special handling service database hosted on a second server separate from the first server; scanning means for scanning the mail piece and retrieving the sorting database record for the mail piece during a second sorting operation, subsequent to the first sorting operation; determining means for determining whether the special handling service is needed by the presence of a control number in the sorting database record; retrieving means for retrieving the special handling service information from the special handling service database using the control number as an index and applying the special handling service information to the mail piece, if the special handling service is needed; and sorting means for sorting the mail piece according to the special handling service information.

The special handling service may be mail forwarding and the special handling service information may include forwarding address text.

According to a fourteenth aspect a method for sorting mail is provided. The method may include reading an address on a mail piece during a first sorting operation, assigning a unique identification number to the mail piece, determining if the mail piece is in need of a special handling service, storing information read from the mail piece and the unique identification number in a record of a database indexed by mail piece identification number, the database hosted on a first server and the record corresponding to the unique identification number assigned to the mail piece, storing a delivery post code in the database record; if the special handling service is needed for the mail piece, storing a control number in the record and storing special handling service information and the control number in a separate table of the database indexed by control number, without an express notation that the mail piece is in need of the special handling service; during a second sorting operation, subsequent to the first sorting operation, recognizing the mail piece identification number on the mail piece; if the record contains a control number, retrieving special handling service information from the separate table; and applying new delivery information to the mail piece according to the special handling service information.

The special handling service may be mail forwarding and the special handling service information may include forwarding address text.

According to a fifteenth aspect a mail processing system is provided. The system may include recognizing means for recognizing an address read from a scanned mail piece during a first sorting operation, means for assigning a unique identification number to the mail piece and means for determining if the mail piece is in need of a special handling service, a database for storing information read from the mail piece, the database being hosted on a first server and indexed by mail piece identification number, and a printer for applying special handling information to the mail piece if needed, storing means for storing a delivery post code in the database record, and, if the special handling service is needed for the mail piece, storing a control number in the record; storing means for storing special handling service information and the control number in a separate table of the database indexed by control number, without an express notation that the mail piece is in need of the special handling service; recognizing means for recognizing the mail piece identification number on the mail piece, during a second sorting operation, subsequent to the first sorting operation; retrieving means for retrieving special handling service information from the separate table, if the record contains a control number; and applying means for applying new delivery information to the mail piece according to the special handling service information.

The recognizing means may include accepting input from a video coding operator.

The special handling service may be mail forwarding and the special handling information may include forwarding address text.

According to a sixteenth aspect a method for sorting mail is provided. The method may include reading an address on a mail piece during a sorting pass, assigning a unique identification number to the mail piece, determining if the mail piece is in need of a special handling service, storing information read from the mail piece and the unique identification number in a record of a database indexed by mail piece identification number, the database hosted on a first server and the record corresponding to the unique identification number assigned to the mail piece, storing a delivery post code in the database record; if the special handling service is needed, storing a control number and special handling service information in the record, without a separate notation that the mail piece is in need of the special handling service; recording the control number and a special handling service type, in a logically separate table indexed by control number; in a subsequent sorting process, scanning the mail piece and retrieving the database record for the mail piece; determining whether the special handling service is needed by using the control number retrieved in the database record as an index to access the logically separate table; if the special handling service is needed, then retrieving the special handling service information and applying the special handling service information to the mail piece if needed; and sorting the mail piece according to the special handling service information.

The special handling service may be mail forwarding and the special handling service information may include forwarding address text.

According to a seventeenth aspect a mail processing system is provided. The system may include recognizing means for recognizing an address read from a scanned mail piece during a first sorting operation, means for assigning a unique identification number to the mail piece and means for determining if the mail piece is in need of a special handling service, a database for storing information read from the mail piece, the database being hosted on a first server and indexed by mail piece identification number, and a printer for applying special handling information to the mail piece if needed, storing means for storing a delivery post code in the database record, and if the special handling service is needed, storing a control number and special handling service information in the record, without a separate notation that the mail piece is in need of the special handling service; recording means for recording the control number and a special handling service type, in a logically separate table indexed by control number; scanning means for scanning the mail piece and retrieving the database record for the mail piece, in a subsequent sorting process; determining means for determining whether the special handling service is needed by using the control number retrieved in the database record as an index to access the logically separate table; retrieving means for retrieving the special handling service information and applying the special handling service information to the mail piece if needed, if the special handling service is needed; and sorting means for sorting the mail piece according to the special handling service information.

The recognizing means may include accepting input from a video coding operator.

The special handling service may be mail forwarding and the special handling information may include forwarding address text.

### BRIEF DESCRIPTION OF THE DRAWINGS

FIG. 1 is a flowchart of an exemplary embodiment of a method for mail forwarding and special handling services without an express notation of the need for the special handling service being stored and with application of special handling information done offline;

FIG. 2 is a flowchart of an exemplary embodiment of a method for mail forwarding and special handling services without an express notation of the need for the special handling service being stored and with application of special handling information done online;

FIG. 3 is a flowchart of an exemplary embodiment of a method for mail forwarding and special handling services with a scannable symbol used to indicate a need for special handling;

FIG. 4 is a flowchart of an exemplary embodiment of a method for mail forwarding and special handling services with a dedicated data record field used to indicate a need for special handling;

FIG. 5 is a flowchart of an exemplary embodiment of a method for mail forwarding and special handling services with an extra digit in a post code used to indicate a need for special handling;

FIG. 6 is a flowchart of an exemplary embodiment of a method for mail forwarding and special handling services with a control number used to access special handling information;

FIG. 7 is a flowchart of an exemplary embodiment of a method for mail forwarding and special handling services with a control number used to access special handling information;

FIG. 8 is a flowchart of an exemplary embodiment of a method for mail forwarding and special handling services with a control number used to access special handling information;

FIG. 9 is a block diagram of an exemplary embodiment of a system for mail forwarding and special handling services with a control number database; and

FIG. 10 is a block diagram of an exemplary embodiment of a system for mail forwarding and special handling services with a control number database.

### DETAILED DESCRIPTION

In the figures and corresponding descriptions, some details of typical mail processing operations have been omitted for the sake of clarity and simplicity in the explanation of the embodiments. It should be appreciated that some or all of these details may be applicable to one or more embodiments. To avoid repetition and more clearly set forth certain distinctive features of the embodiments described herein, some of these details are described once below and may apply to one or more embodiments.

For example, one or more embodiments of a method in accordance with the present invention can include reading an address on a mail piece during a sorting operation, assigning a unique identification number to the mail piece, determining if the mail piece is in need of a special handling service, and storing information read from the mail piece and the unique identification number in a database indexed by mail piece identification number.

The step of reading the address on a mail piece may be performed automatically by a hardware and/or software system (e.g., an optical character recognition (OCR) system), by a manual process (e.g., video coding), or by a combination of automatic and manual processes.

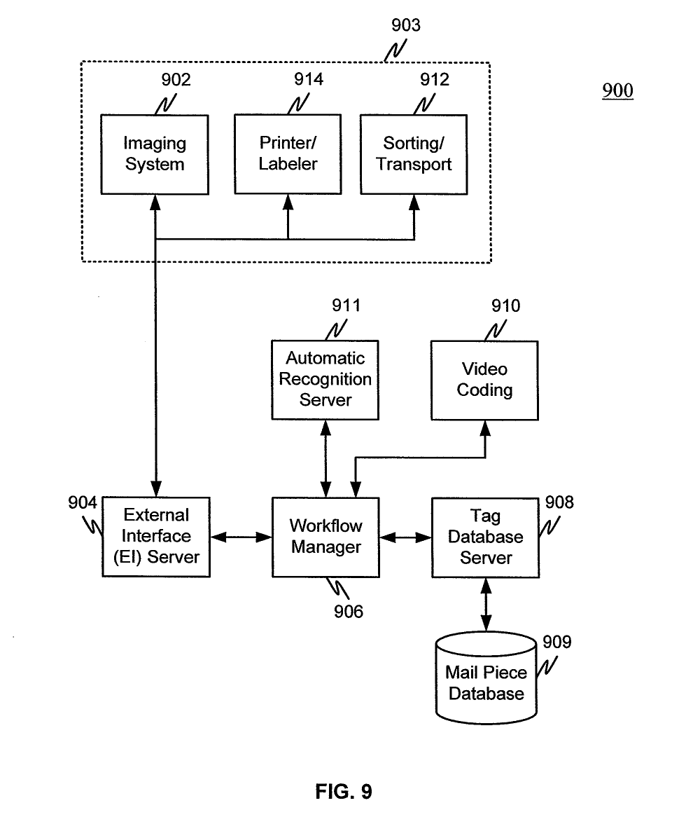

The images of the mail piece can be obtained, for example, using a digital camera (photograph or video), or other now known or later developed imaging device. The step of determining if the mail piece is in need of special handling (e.g., forwarding) may include referencing an internal or external database or system, performing an analysis of the mail piece, and/or the like. Assigning a unique identification number may include other steps inherent to the process such as first generating a unique identification number. For example, the assigning of a unique identification number can be under the control of a mail processing transport (see, for example, 903 of FIG. 9 described below), and conveyed from there to an external interface server and on to other components or processor of a system.

In another example of elements omitted for clarity, at least one embodiment of a mail processing or sorting system in accordance with the present invention can include recognizing means for recognizing an address read from a scanned mail piece, means for assigning a unique identification number to the mail piece and means for determining if the mail piece is in need of a special handling service, a database for storing information read from the mail piece, the database being indexed by mail piece identification number, and a printer for applying special handling information to the mail piece if needed.

The recognizing means may include an electronic or computer hardware and/or software system for automatically recognizing an address (and other information such as special handling notations, postage, and/or the like) on a mail piece (e.g., an optical character recognition (OCR) system), a human for performing a manual process (e.g., video coding), or by a combination of automatic apparatus and a human performing a manual processes. For example, the recognizing could include an automatic recognition system that is adapted to receive a portion of the address from input by a human video coding operator.

The phrase “mail piece” as used herein refers to letters, flats, parcels, and/or the like. In general, any addressed item in need of sorting for delivery can be processed according to the methods—and with the systems—described herein. Although the methods and systems described herein relate to processing and sorting of physical mail pieces, it should be understood that a mail piece may be a physical object (such as an envelope or box), an electronic representation of a physical object (e.g., an image of a envelope and/or a letter contained therein), an encoded digital or analog electronic message (e-mail), or the like. In the case of the electronic representations and encoded messages, these may be intermediate forms of the mail piece and a physical mail piece, suitable for delivery by mail carrier, may be produced once a sorting operation is complete. In other words the mail piece may originate as an electronic object or as a physical object that is converted to an electronic object, and both may ultimately be sorted and/or delivered as a physical object.

The mail piece can be scanned, for example, using a line scanner, a digital camera (still picture or video), or other now known or later developed imaging device. The processor for assigning a unique identification number and determining if the mail piece is in need of special handling (e.g., forwarding) may include an internal or external database or system, performing an analysis of the mail piece, and/or the like. Assigning a unique identification number may include other steps inherent to the process such as first generating a unique identification number.

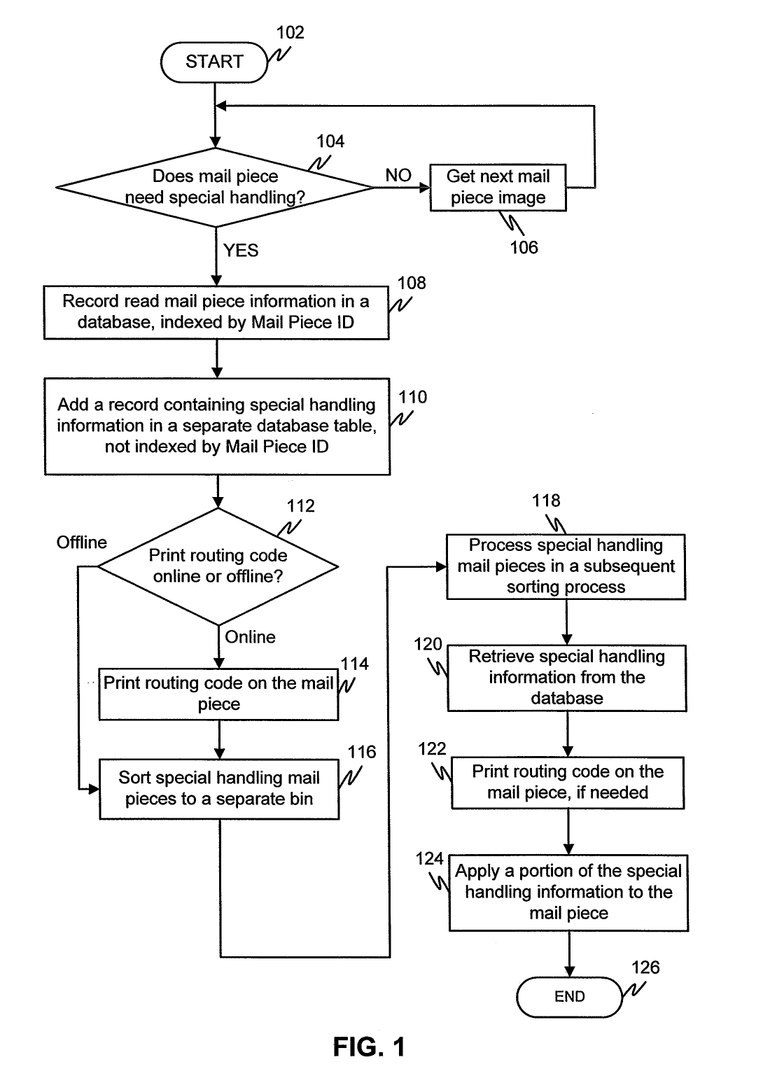

FIG. 1 is a flowchart of an exemplary embodiment of a method for mail forwarding and special handling services. In particular, FIG. 1 shows a method of operation for mail forwarding and special handling services in which the method does not store an express notation (e.g., as entered by an operator) that a mail piece is in need for the special handling service and with application of special handling information done offline. The method may include both online machine processing operations, which may occur during the initial mail recognition and sorting processing and may occur on a variety of different mail scanning, sorting and processing systems. Operations or processes can occur online (i.e., in a single sorting pass whereby the mail piece is processed and sorted without a need for a subsequent sorting process at that station or post office), offline (i.e., in a subsequent sorting operation, such as batch processing), or in a combination of online and offline operations.

Generally, batch processing can occur in a system separate from the system used for the initial mail recognition and sorting processing, although the initial system may still be used in a subsequent process. For example, FIG. 1 includes a first portion of the method that occurs in a first, single transport pass and a second portion of the method that occurs in a subsequent process on the same equipment used for the first, single transport pass or different equipment.

Turning to the flowchart shown in FIG. 1, the method of operation begins at step 102. Prior to the start of the method at step 102, other steps or operations not shown may have been performed, as discussed above. Operation continues to step 104.

In step 104, it is determined whether a mail piece is in need of special handling. If the mail piece is not in need of special handling, the method continues to step 106, where a next mail piece image is retrieved. It should be appreciated that the flowchart of FIG. 1 (and other flowcharts described herein) includes those steps related to the processing of mail in need of a special handling service. If a mail piece does not need special handling, then there will be other steps not shown to sort the mail piece. If it is determined that the mail piece is in need of a special handling service, then operation continues to step 108.

In step 108, the mail piece information read from the mail piece is stored in a record of a database at an index corresponding to the mail piece identification number (assigned in a step not shown) to the mail piece. The mail piece information can include a copy of a portion of the image of the mail piece, the read destination address, the read return address, a routing or post code, special handling or other indications read from the mail piece image, the postage, information derived from any of the above, and/or the like. The mail piece information can also include certain special handling information, such as a routing or post code associated with special handling information and a portion of the special handling information. For example, the forwarding address and forwarding post code can be recorded in the mail piece record indexed by mail piece identification number, without recording an express notation in the database record that the mail piece is in need of forwarding. In some cases, an indication that the item is in need of a special handling service may be recorded in the database, such as, for example, for the special handling case where the mail piece is to be held at the delivery office for pick-up by the recipient (or addressee). Operation continues to step 110.

In step 110, a different record can be optionally added to a separate table of the database that uses an index other than the mail piece identification number. The different record can include special handling details such as sender, recipient, old address data, and new address data. The mail piece identification number can be included in the different record, but not usable by the database as an index (or key) value or searchable for the separate table. Operation continues to step 112.

In step 112, it is determined whether to print the routing code online or offline. If it is determined that the routing code (or post code) is to be printed online, operation continues to step 114. On the other hand, if it is determined that the routing code is to be printed offline, operation continues to step 116.

In step 114, the routing code is printed on the mail piece. The phrase “printed” as used herein can refer to actually printing on the mail piece or printing on a label (or other article) that can then be applied to the mail piece. Also, the printing may be done using visible or invisible ink. The printed information may be adapted for reading by human, by machine, or both. Control continues to step 116.

In step 116, mail pieces requiring special handling services are sorted to a separate bin. The mail pieces may be sorted into one common bin for special handling services, or may be sorted into one or more bins according to the type of special handling service needed. Control continues to step 118.

In step 118, the mail pieces sorted to a special bin are processed in a subsequent sorting operation, for example, in batch processing of forwarded mail. This subsequent processing of the special handling mail can occur on the same or different equipment as the first sorting operation. Typically, the special handling mail will be processed on a transport capable of printing and applying address labels or other types of labels. Control continues to step 120.

In step 120, special handling information for the mail piece in need of special handling is retrieved from the different table of the database. As a part of the retrieval process not shown, the mail piece unique identification number can be read and used as an index or key value for accessing a corresponding record of the database, and then, based on the corresponding record, the different table may be accessed with a key other than mail piece identification number. Control continues to step 122.

In step 122, a routing code can be printed on the mail piece, if needed. If the routing code has been already printed online in step 114, then another printing of the routing code may not be necessary. However, if the first routing code printed on the mail piece corresponds to an old or former address, for example, then a second printing of the routing code may be needed to place a routing code corresponding to a forwarding address on the mail piece. Control continues to step 124.

In step 124, a portion of the special handling information can be applied to the mail piece. For example, in the case of a mail piece in need of forwarding, the forwarding address text can be printed on a label, which is then applied to the mail piece so as to obscure the old address. Control continues to step 126, where the method ends.

Steps 104-116 can occur during a first, single transport (or sorting) pass/operation. Steps 118-124 can occur during a second, subsequent transport (or sorting) pass/operation. The first and second transport pass/operations may occur on the same or different sorting/transport equipment. It should also be appreciated that the method of FIG. 1 may be repeated in whole or in part to complete a contemplated mail sorting task.

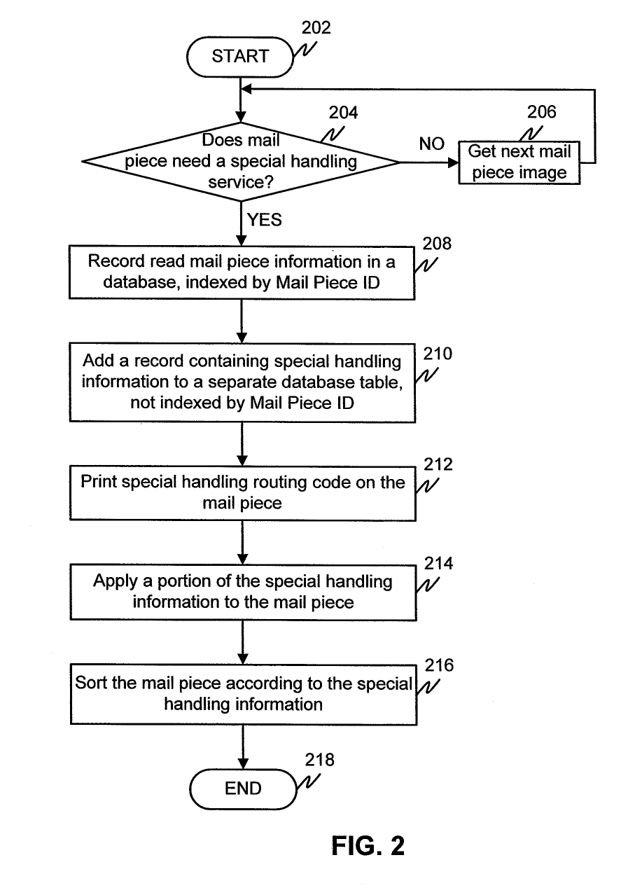

FIG. 2 is a flowchart of an exemplary embodiment of a method for mail forwarding and special handling services. In particular the method of FIG. 2 includes processing (or sorting) without an express notation of the need for the special handling service being stored in the database and with application of special handling information being done online, i.e., the method occurs in a single transport/sorting pass without a second part that occurs in a subsequent transport/sorting process.

Turning to the flowchart shown in FIG. 2, the method of operation (or control) begins at step 202. Prior to the start of the method (or operation) at step 202, other steps or operations not shown may have been performed, as discussed above. Operation continues to step 204.

In step 204, it is determined whether a mail piece is in need of special handling. If the mail piece is not in need of special handling, the method continues to step 206, where a next mail piece image is retrieved. It should be appreciated that the flowchart of FIG. 2 (and other flowcharts described herein) includes those steps related to the processing of mail in need of a special handling service. If a mail piece does not need special handling, then there will be other steps not shown to sort the mail piece. If it is determined that the mail piece is in need of a special handling service, then operation continues to step 208.

In step 208, the mail piece information read from the mail piece is stored in a record of a database at an index corresponding to the mail piece identification number (assigned in a step not shown) to the mail piece. The mail piece information can include a copy of a portion of the image of the mail piece, the read destination address, the read return address, a routing or post code, special handling or other indications read from the mail piece image, the postage, information derived from any of the above, and/or the like. The mail piece information can also include certain special handling information, such as a routing or post code associated with special handling information and a portion of the special handling information. For example, the forwarding address and forwarding post code can be recorded in the mail piece record indexed by mail piece identification number, without recording an express notation in the database record that the mail piece is in need of forwarding. In some cases, an indication that the item is in need of a special handling service may be recorded in the database, such as, for example, for the special handling case where the mail piece is to be held at the delivery office for pick-up by the recipient (or addressee). Operation continues to step 210.

In step 210, a different record can be optionally added to a separate database table that uses an index other than the mail piece identification number. The different record can include special handling details such as sender, recipient, old address data, and new address data. The mail piece identification number can be included in the different record, but not usable by the database as an index (or key) value or searchable for the separate table. Operation continues to step 212.

In step 212, a routing code can be printed on the mail piece. Operation continues to step 214.

In step 214, special handling information for the mail piece in need of special handling is retrieved from the database. Optionally, as a part of the method not shown, the mail piece unique identification number can be read from the mail piece and used as an index or key value for accessing a corresponding record of the database. Control continues to step 216.

In step 216, the mail piece can be sorted according to the special handling information and/or routing code applied to the mail piece. Operation continues to step 218 where the method ends. It should also be appreciated that the method of FIG. 2 may be repeated in whole or in part to complete a contemplated mail sorting task. Also, for online forwarding (i.e., the case where the determination of forwarding and printing of the new address occurs in a single transport pass), it may not be necessary to retain the forwarding information in a database indexed by mail piece identification number. In certain online systems, mail pieces can be mechanically tracked by sensors as they move through the transport, so the system can save the forwarding information and retrieve it for printing downstream, based on sensor tracking, for example.

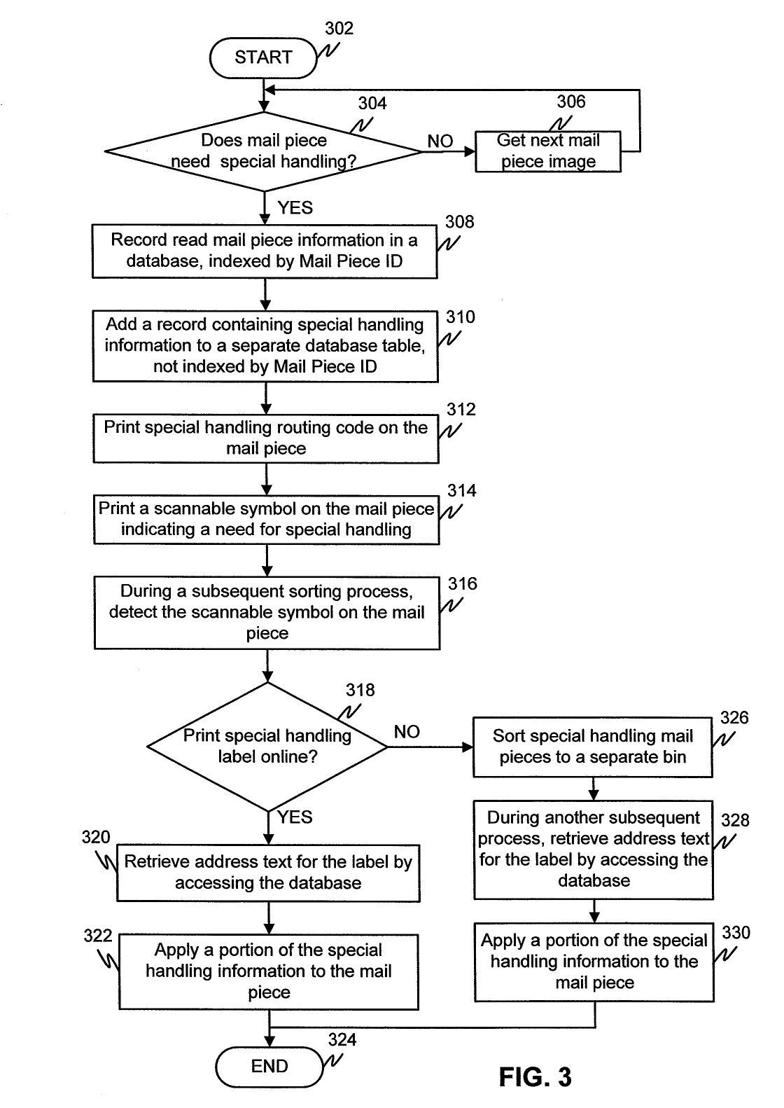

FIG. 3 is a flowchart of an exemplary embodiment of a method for mail forwarding and special handling services with a scannable symbol used to indicate a need for special handling.

Turning to the flowchart shown in FIG. 3, the method of operation (or control) begins at step 302. Prior to the start of the method (or operation) at step 302, other steps or operations not shown may have been performed, as discussed above. Operation continues to step 304.

In step 304, it is determined whether a mail piece is in need of special handling. If the mail piece is not in need of special handling, the method continues to step 306, where a next mail piece image is retrieved. It should be appreciated that, for clarity of explanation and description of the embodiment, the flowchart of FIG. 3 (and other flowcharts described herein) includes those steps related to the processing of mail in need of a special handling service. If a mail piece does not need special handling, then there will be other steps not shown to sort the mail piece. If it is determined that the mail piece is in need of a special handling service, then operation continues to step 308.

In step 308, the mail piece information read from the mail piece is stored in a record of a database at an index corresponding to the mail piece identification number (assigned in a step not shown) to the mail piece. The mail piece information can include a copy of a portion of the image of the mail piece, the read destination address, the read return address, a routing or post code, special handling or other indications read from the mail piece image, the postage, information derived from any of the above, and/or the like. The mail piece information can also include certain special handling information, such as a routing or post code associated with special handling information and a portion of the special handling information. For example, the forwarding address and forwarding post code can be recorded in the mail piece record indexed by mail piece identification number, without recording an express notation in the database record that the mail piece is in need of forwarding. In some cases, an indication that the item is in need of a special handling service may be recorded in the database, such as, for example, for the special handling case where the mail piece is to be held at the delivery office for pick-up by the recipient (or addressee). Operation continues to step 310.

In step 310, a different record can be optionally added to a separate database table that uses an index other than the mail piece identification number. The different record can include special handling details such as sender, recipient, old address data, and new address data. The mail piece identification number can be included in the different record, but not usable by the database as an index (or key) value or searchable for the separate table. Operation continues to step 312.

In step 312, a routing code can be printed on the mail piece. Operation continues to step 314.

In step 314, a scannable symbol is printed on the mail piece. The scannable symbol can be an indicator that the mail piece is in need of a special handling service. The scannable symbol can be adapted to be read and recognized by a machine, by a human, or both. For example, if the mail piece transport being used applies a routing barcode (that may be in addition to the unique mail piece identification barcode) the scannable symbol can be a variation of the routing barcode such that further sorting equipment can detect the variation as a special handling service indicator. Alternatively, the scannable symbol can be a stand alone symbol used for indicating that a special handling service is needed and scannable or recognizable by a machine and/or human. Operation continues to step 316.

In step 316, the scannable symbol is detected, read or recognized in a subsequent sorting operation (or process), for example, in batch processing of forwarded mail. This subsequent processing of the special handling mail can occur on the same or different equipment as the first sorting operation. Typically, the special handling mail will be processed on a transport capable of printing and applying address labels or other types of labels. In the case of this embodiment, the subsequent sorting operation can be carried out on transport or sorting equipment capable of recognizing the scannable symbol. Operation continues to step 318.

In step 318, it is determined whether the special handling information is to be printed online or offline. If online, operation continues to step 320. If offline, operation continues to step 326.

In step 320, special handling information, such as address text, can be retrieved from the database in preparation for application to the mail piece. Operation continues to step 322.

In step 322, the special handling information retrieved in step 320, or a portion thereof, can be applied to the mail piece. Operation continues to step 324, where the method ends.

In the case of offline printing, operation continued from step 318 to step 326.

In step 326, mail pieces in need of special handling are sorted to one or more separate bins. The mail pieces may be sorted into one common bin for special handling services, or may be sorted into one or more bins according to the type of special handling service needed. Control continues to step 328.

In step 328, special handling information, such as address text, can be retrieved from the database during another subsequent sorting process, for example, in batch processing of forwarded mail. This subsequent processing of the special handling mail can occur on the same or different equipment as the first sorting operation. Typically, the special handling mail will be processed on a transport capable of printing and applying address labels or other types of labels. Operation continues to step 330.

In step 330, the special handling information retrieved in step 328, or a portion thereof, can be applied to the mail piece. Operation continues to step 324, where the method ends. It should also be appreciated that the method of FIG. 3 may be repeated in whole or in part to complete a contemplated mail sorting task.

The storing of special handling information in a separate table (or separate database) as mentioned above in steps 110, 210 and 310 may be done for the purpose of recording information useful to a mailer (such as the recipient's new address), if the mailer has subscribed to, or requested, such optional address services.

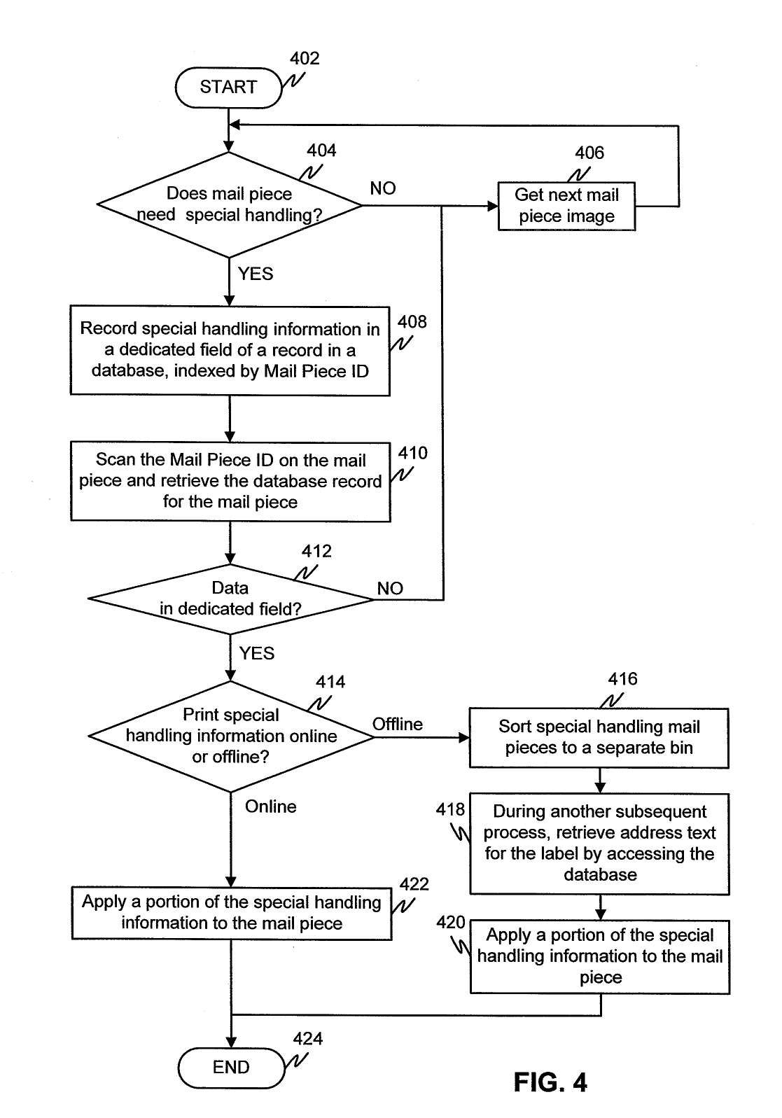

FIG. 4 is a flowchart of an exemplary embodiment of a method for mail forwarding and special handling services with a dedicated data record field used to indicate a need for special handling.

Turning to the flowchart shown in FIG. 4, the method of operation (or control) begins at step 402. Prior to the start of the method (or operation) at step 402, other steps or operations not shown may have been performed, as discussed above. Operation continues to step 404.

In step 404, it is determined whether a mail piece is in need of special handling. If the mail piece is not in need of special handling, the method continues to step 406, where a next mail piece image is retrieved. It should be appreciated that, for clarity of explanation and description of the embodiment, the flowchart of FIG. 4 (and other flowcharts described herein) includes those steps related to the processing of mail in need of a special handling service. If a mail piece does not need special handling, then there will be other steps not shown to sort the mail piece. If it is determined that the mail piece is in need of a special handling service, then operation continues to step 408.

In step 408, the mail piece information read from the mail piece is stored in a record of a database at an index corresponding to the mail piece identification number (assigned in a step not shown) to the mail piece. The mail piece information can include a copy of a portion of the image of the mail piece, the read destination address, the read return address, a routing or post code, special handling or other indications read from the mail piece image, the postage, information derived from any of the above, and/or the like. The mail piece information can also include certain special handling information, such as a routing or post code associated with special handling information and a portion of the special handling information. The special handling information can be recorded in a dedicated field of the database record. For example, the forwarding address and forwarding post code can be recorded in a dedicated field of the mail piece record indexed by mail piece identification number, without recording an express notation in the database record that the mail piece is in need of forwarding. In some cases, an indication that the item is in need of a special handling service may be recorded in the database, such as, for example, for the special handling case where the mail piece is to be held at the delivery office for pick-up by the recipient (or addressee). Operation continues to step 410.

In step 410, the mail piece is scanned, either in the same or a different, subsequent sorting operation and the unique mail piece identification number can be read. Using the mail piece identification number, the database record corresponding to the mail piece can be retrieved and the dedicated field can be checked for data. Operation continues to step 412.

In step 412, it is determined whether the dedicated field contains data or not. If the dedicated field contains data, then operation continues to step 414, otherwise operation continues back to step 406.

In step 414, it is determined whether the special handling information is to be printed online or offline. If online, operation continues to step 422. If offline, operation continues to step 416.

In step 422, the special handling information retrieved in step 410, or a portion thereof, can be applied to the mail piece. Operation continues to step 424, where the method ends.

In the case of offline printing, operation continued from step 414 to step 416.

In step 416, mail pieces in need of special handling can be sorted to one or more separate bins. The mail pieces may be sorted into one common bin for special handling services, or may be sorted into one or more bins according to the type of special handling service needed. Control continues to step 418.

In step 418, special handling information, such as address text, can be retrieved from the database during another subsequent sorting process, for example, in batch processing of forwarded mail. This subsequent processing of the special handling mail can occur on the same or different equipment as the first sorting operation. Typically, the special handling mail will be processed on a transport capable of printing and applying address labels or other types of labels. Operation continues to step 420.

In step 420, the special handling information retrieved in step 418, or a portion thereof, can be applied to the mail piece. Operation continues to step 424, where the method ends. It should also be appreciated that the method of FIG. 4 may be repeated in whole or in part to complete a contemplated mail sorting task.

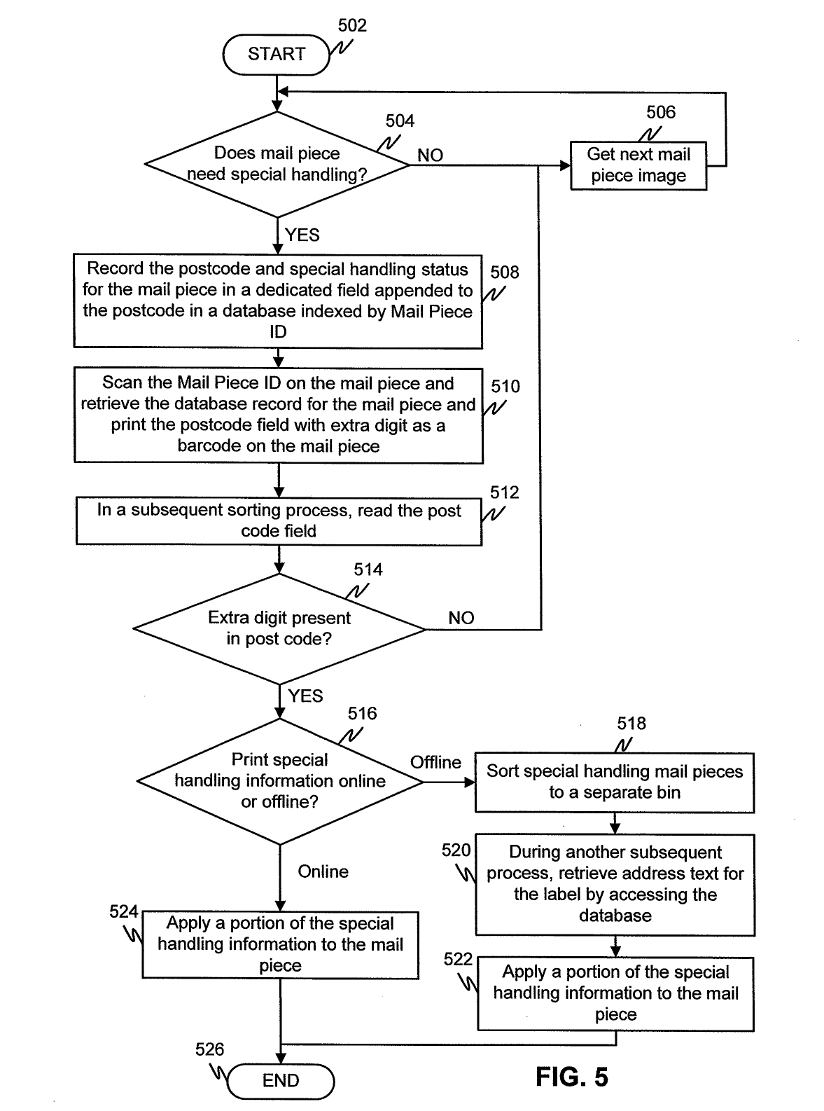

FIG. 5 is a flowchart of an exemplary embodiment of a method for mail forwarding and special handling services with an extra digit in a post code used to indicate a need for special handling, in which the method of operation (or control) begins at step 502. Prior to the start of the method (or operation) at step 502, other steps or operations not shown may have been performed, as discussed above. Operation continues to step 504.

In step 504, it is determined whether a mail piece is in need of special handling. If the mail piece is not in need of special handling, the method continues to step 506, where a next mail piece image is retrieved. It should be appreciated that, for clarity of explanation and description of the embodiment, the flowchart of FIG. 5 (and other flowcharts described herein) includes those steps related to the processing of mail in need of a special handling service. If a mail piece does not need special handling, then there will be other steps not shown to sort the mail piece. If it is determined that the mail piece is in need of a special handling service, then operation continues to step 508.

In step 508, the mail piece information read from the mail piece is stored in a record of a database at an index corresponding to the mail piece identification number (assigned in a step not shown) to the mail piece. The mail piece information can include a copy of a portion of the image of the mail piece, the read destination address, the read return address, a routing or post code, special handling or other indications read from the mail piece image, the postage, information derived from any of the above, and/or the like. The mail piece information can also include certain special handling information, such as a routing or post code associated with special handling information and a portion of the special handling information. The special handling information can be recorded in a dedicated field of the database record that is appended to the post code. For example, the forwarding address and forwarding post code can be recorded in a dedicated field of the mail piece record indexed by mail piece identification number, without recording an express notation in the database record that the mail piece is in need of forwarding. In some cases, an indication that the item is in need of a special handling service may be recorded in the database, such as, for example, for the special handling case where the mail piece is to be held at the delivery office for pick-up by the recipient (or addressee). Operation continues to step 510.

In step 510, the mail piece is scanned, either in the same or a different, subsequent sorting operation and the unique mail piece identification number can be read. Using the mail piece identification number, the database record corresponding to the mail piece can be retrieved and the dedicated field can be checked for data. If the dedicated field contains data, then the post code can be printed on the mail piece with an extra digit appended. The post code being printed in a format that is machine readable (e.g., a bar code) or human readable, or both. Operation continues to step 512.

In step 512, in a subsequent sorting operation, the post code is read form the mail piece. Operation continues to step 514.

In step 514, it is determined whether the post code contains an extra digit or not. If the post code contains an extra digit, then operation continues to step 516, otherwise operation continues back to step 506.

In step 516, it is determined whether the special handling information is to be printed online or offline. If online, operation continues to step 524. If offline, operation continues to step 518.

In step 524, the special handling information can be retrieved and a portion thereof can be applied to the mail piece. Operation continues to step 526, where the method ends.

In the case of offline printing, operation continued from step 516 to step 518.

In step 518, mail pieces in need of special handling can be sorted to one or more separate bins. The mail pieces may be sorted into one common bin for special handling services, or may be sorted into one or more bins according to the type of special handling service needed. Control continues to step 520.

In step 520, special handling information, such as address text, can be retrieved from the database during another subsequent sorting process, for example, in batch processing of forwarded mail. This subsequent processing of the special handling mail can occur on the same or different equipment as the first sorting operation. Typically, the special handling mail will be processed on a transport capable of printing and applying address labels or other types of labels. Operation continues to step 522.

In step 522, the special handling information retrieved in step 518, or a portion thereof, can be applied (or printed) on the mail piece. Operation continues to step 526, where the method ends. It should also be appreciated that the method of FIG. 5 may be repeated in whole or in part to complete a contemplated mail sorting task.

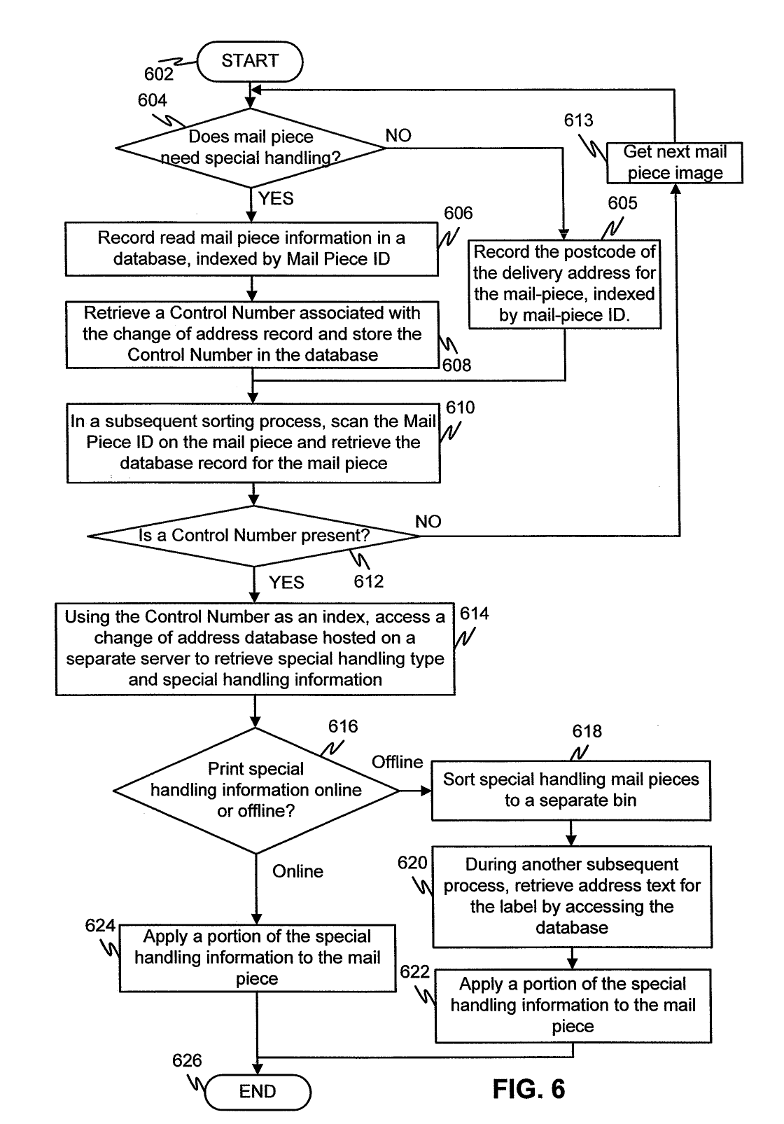

FIG. 6 is a flowchart of an exemplary embodiment of a method for mail forwarding and special handling services with a control number used to access special handling information in which the method of operation (or control) begins at step 602. Prior to the start of the method (or operation) at step 602, other steps or operations not shown may have been performed, as discussed above. Operation continues to step 604.

In step 604, it is determined whether a mail piece is in need of special handling. If the mail piece is not in need of special handling, the method continues to step 605, where the post code of the delivery address for the mail piece is stored in a database record corresponding to the unique mail piece identification number. This post code information is recorded for all mail pieces, forwarded or not, to support sorting and routing of the mail. Depending on applicability and type of forwarding, the postcode may be for the original address, return address, or forwarded address. Operation continues from step 605 to step 610, described below. If it is determined that the mail piece is in need of a special handling service, then operation continues to step 606.

It should be appreciated that, for clarity of explanation and description of the embodiment, the flowchart of FIG. 6 (and other flowcharts described herein) focuses on those steps related to the processing of mail in need of a special handling service. If a mail piece does not need special handling, then other steps not shown may be performed to sort the mail piece.

In step 606, the mail piece information read from the mail piece is stored in a record of a database at an index corresponding to the mail piece identification number (assigned in a step not shown) to the mail piece. Similar information may also be recorded in step 605. The mail piece information can include a copy of a portion of the image of the mail piece, the read destination address, the read return address, a routing or post code, special handling or other indications read from the mail piece image, the postage, information derived from any of the above, and/or the like. The mail piece information can also include certain special handling information, such as a routing or post code associated with special handling information and a portion of the special handling information. The special handling information can be recorded in a dedicated field of the database record that is appended to the post code. For example, the forwarding address and forwarding post code can be recorded in a dedicated field of the mail piece record indexed by mail piece identification number, without recording an express notation in the database record that the mail piece is in need of forwarding. In some cases, an indication that the item is in need of a special handling service may be recorded in the database, such as, for example, for the special handling case where the mail piece is to be held at the delivery office for pick-up by the recipient (or addressee). Operation continues to step 608.

In step 608, a control number associated with a special handling record is retrieved and the control number is stored in the database at the record associated with the mail piece identification number. For example, the control number may be a 10-digit control number associated with a change of address record for a particular person or delivery destination. The control number may represent that a person has requested a special handling service, but may not indicate expressly which special handling service has been requested. In order to determine the nature of the special handling service requested and to obtain special handling information, the system may use the control number to access another database as described below. Operation continues to step 610.

In step 610, the mail piece is scanned to obtain the mail piece identification number and the database record associated with that mail piece identification number is retrieved. Operation continues to step 612.

In step 612, it is determined whether the record retrieved from the database in step 610 contains a control number. If the record does not contain a control number, operation continues to step 613 where a next mail piece image is retrieved. If the record contains a control number, operation continues to step 614.

In step 614, the control number can be used as index or key value to access a control number database hosted on a separate server from the database indexed by mail piece identification number. The control number database can contain the control number and special handling information such as, for example, forwarding type and forwarding address text. The control number database may be a change of address database or an extract of a change of address database containing only predetermined fields. Alternatively, the control number database may contain data extracted or derived from one or more databases such as change of address records, valid address records, special handling request records, and/or the like. Other special handling information may be stored in the control number table. Operation continues to step 616.

In step 616, it is determined whether the special handling information is to be printed online or offline. If online, operation continues to step 624. If offline, operation continues to step 618.

In step 624, the special handling information can be retrieved from the control number database and a portion thereof can be applied to the mail piece. Operation continues to step 626, where the method ends.

In the case of offline printing, operation continued from step 616 to step 618.

In step 618, mail pieces in need of special handling can be sorted to one or more separate bins. The mail pieces may be sorted into one common bin for special handling services, or may be sorted into one or more bins according to the type of special handling service needed. Control continues to step 620.

In step 620, special handling information, such as address text, can be retrieved from the control number database using the control number as a key or index value during another subsequent sorting process, for example, in batch processing of forwarded mail. This subsequent processing of the special handling mail can occur on the same or different equipment as the first sorting operation. Typically, the special handling mail will be processed on a transport capable of printing and applying address labels or other types of labels. In order to obtain the control number for use in retrieving the special handling information, the mail piece id tag can be read, and used as an index to retrieve the database record (created in step 608) that contains the control number. Operation continues to step 622.

In step 622, the special handling information retrieved in step 618, or a portion thereof, can be applied (or printed) on the mail piece. Operation continues to step 626, where the method ends. It should also be appreciated that the method of FIG. 6 may be repeated in whole or in part to complete a contemplated mail sorting task.

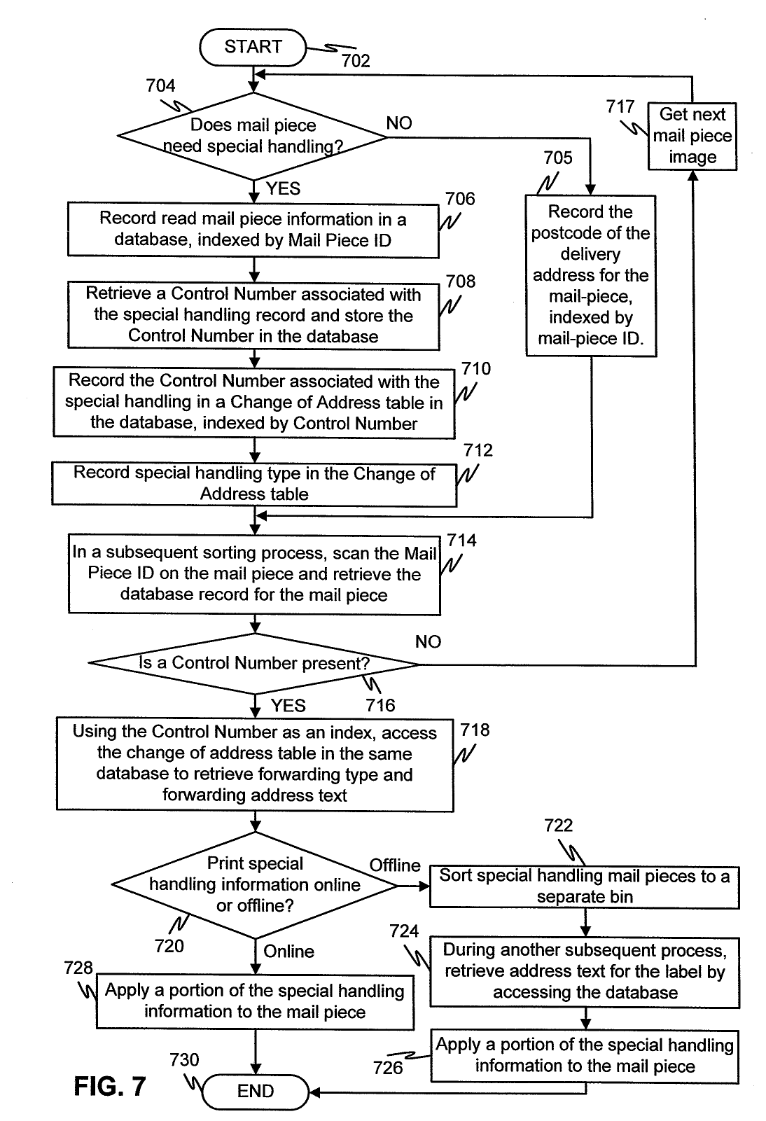

FIG. 7 is a flowchart of an exemplary embodiment of a method for mail forwarding and special handling services with a control number used to access special handling information in which the method of operation (or control) begins at step 702. Prior to the start of the method (or operation) at step 702, other steps or operations not shown may have been performed, as discussed above. Operation continues to step 704.

In step 704, it is determined whether a mail piece is in need of special handling. If the mail piece is not in need of special handling, the method continues to step 705, where the post code of the delivery address for the mail piece is stored in a mail piece table at a record corresponding to the unique mail piece identification number. This post code information is recorded for all mail pieces, forwarded or not, to support sorting and routing of the mail. Depending on applicability and type of forwarding, the postcode may be for the original address, return address, or forwarded address. Operation continues from step 705 to step 714, described below. If it is determined that the mail piece is in need of a special handling service, then operation continues to step 706.

It should be appreciated that, for clarity of explanation and description of the embodiment, the flowchart of FIG. 7 (and other flowcharts described herein) focuses on those steps related to the processing of mail in need of a special handling service. If a mail piece does not need special handling, then other steps not shown may be performed to sort the mail piece.

In step 706, the mail piece information read from the mail piece is stored in a record of a mail piece table with an index (or key value) corresponding to the mail piece identification number (assigned in a step not shown) to the mail piece. Similar information may also be recorded in step 705. The mail piece information can include a copy of a portion of the image of the mail piece, the read destination address, the read return address, a routing or post code, special handling or other indications read from the mail piece image, the postage, information derived from any of the above, and/or the like. The mail piece information can also include certain special handling information, such as a routing or post code associated with special handling information and a portion of the special handling information. The special handling information can be recorded in a dedicated field of the database record that is appended to the post code. For example, the forwarding address and forwarding post code can be recorded in a dedicated field of the mail piece record indexed by mail piece identification number, without recording an express notation in the database record that the mail piece is in need of forwarding. In some cases, an indication that the item is in need of a special handling service may be recorded in the database, such as, for example, for the special handling case where the mail piece is to be held at the delivery office for pick-up by the recipient (or addressee). Operation continues to step 708.

In step 708, a control number associated with a special handling record is retrieved and the control number is stored in a mail piece table of the database at the record associated with the mail piece identification number. For example, the control number may be a 10-digit control number associated with a change of address record for a particular person or delivery destination. The control number may represent that a person has requested a special handling service, but may not indicate expressly which special handling service has been requested. In order to determine the nature of the special handling service requested and to obtain special handling information, the system may use the control number to access another database as described below. Operation continues to step 710.

In step 710, the control number is stored in a record of a special handling table of the database that is indexed by control number only, and not by mail piece identification number. The record in the special handling table can correspond to the control number. Operation continues to step 712.

In step 712, a special handling type and/or other special handling information associated with the control number can be retrieved and stored in the special handling table at the record associated with the control number. It will be appreciated that the special handling table and/or control number database can be populated in advance of processing the mail piece and may be periodically updated as desired and/or necessary to maintain current delivery information.

In step 714, the mail piece is scanned to obtain the mail piece identification number and the database record associated with that mail piece identification number is retrieved from the mail piece table. Operation continues to step 716.

In step 716, it is determined whether the mail piece table record retrieved from the database in step 714 contains a control number. If the record does not contain a control number, operation continues to step 717 where a next mail piece image is retrieved. If the record contains a control number, operation continues to step 718.

In step 718, the control number can be used as index or key value to access the special handling table in the database. The special handling table can contain the control number and special handling information such as, for example, forwarding type and forwarding address text. The special handling table may include data from a change of address database or an extract of a change of address database containing only predetermined fields. Alternatively, the special handling table may contain data extracted or derived from one or more databases such as change of address records, valid address records, special handling request records, and/or the like. Other special handling information may be stored in the special handling table. Operation continues to step 720.

In step 720, it is determined whether the special handling information is to be printed online or offline. If online, operation continues to step 728. If offline, operation continues to step 722.

In step 728, the special handling information can be retrieved from the control number database and a portion thereof can be applied to the mail piece. Operation continues to step 730, where the method ends.

In the case of offline printing, operation continued from step 720 to step 722.

In step 722, mail pieces in need of special handling can be sorted to one or more separate bins. The mail pieces may be sorted into one common bin for special handling services, or may be sorted into one or more bins according to the type of special handling service needed. Control continues to step 724.

In step 724, special handling information, such as address text, can be retrieved from the special handling table using the control number as a key or index value during another subsequent sorting process, for example, in batch processing of forwarded mail. This subsequent processing of the special handling mail can occur on the same or different equipment as the first sorting operation. Typically, the special handling mail will be processed on a transport capable of printing and applying address labels or other types of labels. Operation continues to step 726.

In step 726, the special handling information retrieved in step 724, or a portion thereof, can be applied (or printed) on the mail piece. Operation continues to step 730, where the method ends. It will be appreciated that the method of FIG. 7 may be repeated in whole or in part to complete a contemplated mail sorting task.

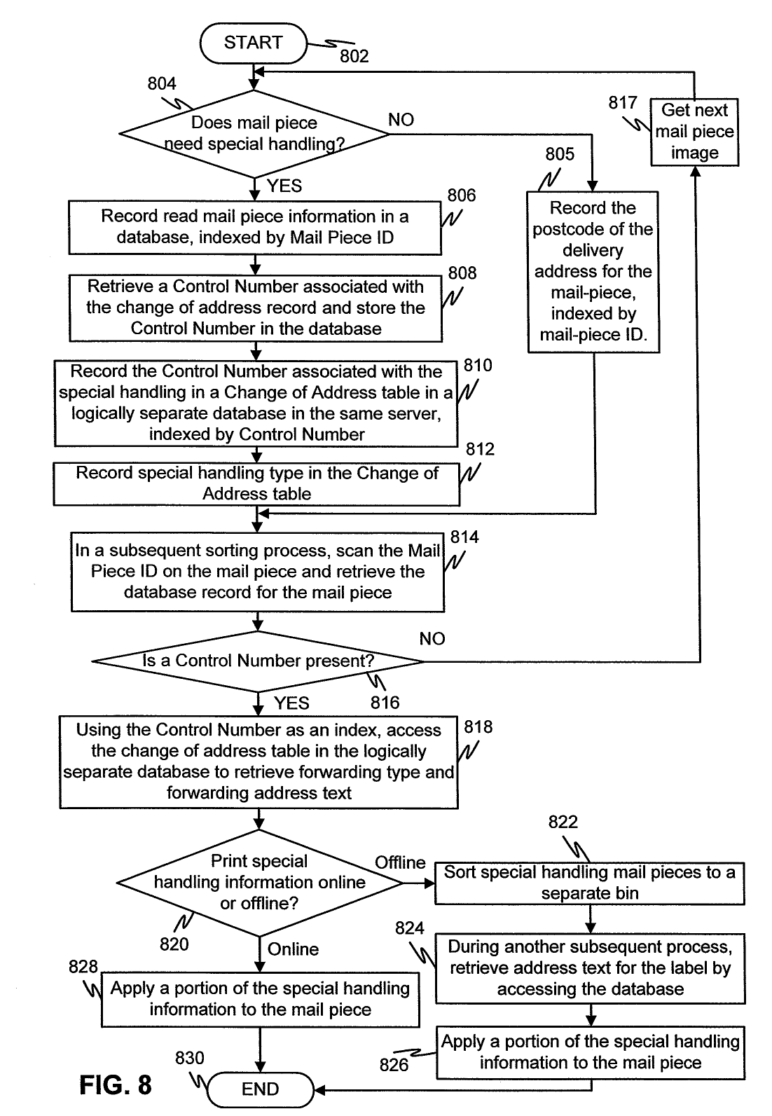

FIG. 8 is a flowchart of an exemplary embodiment of a method for mail forwarding and special handling services with a control number used to access special handling information in which the method of operation (or control) begins at step 802. Prior to the start of the method (or operation) at step 802, other steps or operations not shown may have been performed, as discussed above. Operation continues to step 804.

In step 804, it is determined whether a mail piece is in need of special handling. If the mail piece is not in need of special handling, the method continues to step 805, where the post code of the delivery address for the mail piece is stored in a mail piece table at a record corresponding to the unique mail piece identification number. This post code information is recorded for all mail pieces, forwarded or not, to support sorting and routing of the mail. Depending on applicability and type of forwarding, the postcode may be for the original address, return address, or forwarded address. Operation continues from step 805 to step 814, described below. If it is determined that the mail piece is in need of a special handling service, then operation continues to step 806.

It should be appreciated that, for clarity of explanation and description of the embodiment, the flowchart of FIG. 8 (and other flowcharts described herein) focuses on those steps related to the processing of mail in need of a special handling service. If a mail piece does not need special handling, then other steps not shown may be performed to sort the mail piece.

In step 806, the mail piece information read from the mail piece is stored in a record of a mail piece table with an index (or key value) corresponding to the mail piece identification number (assigned in a step not shown) to the mail piece. Similar information may also be recorded in step 805. The mail piece information can include a copy of a portion of the image of the mail piece, the read destination address, the read return address, a routing or post code, special handling or other indications read from the mail piece image, the postage, information derived from any of the above, and/or the like. The mail piece information can also include certain special handling information, such as a routing or post code associated with special handling information and a portion of the special handling information. The special handling information can be recorded in a dedicated field of the database record that is appended to the post code. For example, the forwarding address and forwarding post code can be recorded in a dedicated field of the mail piece record indexed by mail piece identification number, without recording an express notation in the database record that the mail piece is in need of forwarding. In some cases, an indication that the item is in need of a special handling service may be recorded in the database, such as, for example, for the special handling case where the mail piece is to be held at the delivery office for pick-up by the recipient (or addressee). Also, for all mail pieces, a 10-digit Control Number associated with a change of address record, including a change of address record indicating no forwarding is in effect, where the 10-digit control number can be entered into the record by computer only, not by an operator. Also, text to be printed on envelope if return to sender is needed and/or a sender's special handling instructions, for example, forwarding instruction (e.g. address correction, do not forward, etc.) can be recorded in the record. Operation continues to step 808.

In step 808, a control number associated with a special handling record is retrieved and the control number is stored in a mail piece table of a database. The control number is stored at a record associated with the mail piece identification number. For example, the control number may be a 10-digit control number associated with a change of address record for a particular person or delivery destination. The control number may represent that a person has requested a special handling service, but may not indicate expressly which special handling service has been requested. In order to determine the nature of the special handling service requested and to obtain special handling information, the system may use the control number to access another database as described below. Operation continues to step 810.

In step 810, the control number is stored in a record of a special handling table of a logically separate database that may be contained in the same server as the database having the mail piece table, but which is a logically separate database from the mail piece table database. The special handling table is indexed by control number only, and not by mail piece identification number. The record in the special handling table can correspond to the control number. Operation continues to step 812.

In step 812, a special handling type and/or other special handling information associated with the control number can be retrieved and stored in the special handling table at the record associated with the control number. It will be appreciated that the special handling table and/or control number database can be populated in advance of processing the mail piece and may be periodically updated as desired and/or necessary to maintain current delivery information. Operation continues to step 814.

In step 814, the mail piece is scanned to obtain the mail piece identification number and the database record associated with that mail piece identification number is retrieved from the mail piece table. Operation continues to step 816.

In step 816, it is determined whether the mail piece table record retrieved from the logically separate database in step 814 contains a control number. If the record does not contain a control number, operation continues to step 817 where a next mail piece image is retrieved. If the record contains a control number, operation continues to step 818.

In step 818, the control number can be used as index or key value to access the special handling table in the database. The special handling table can contain the control number and special handling information such as, for example, forwarding type and forwarding address text. The special handling table may include data from a change of address database or an extract of a change of address database containing only predetermined fields. Alternatively, the special handling table may contain data extracted or derived from one or more databases such as change of address records, valid address records, special handling request records, and/or the like. Other special handling information may be stored in the special handling table. Operation continues to step 820.

In step 820, it is determined whether the special handling information is to be printed online or offline. If online, operation continues to step 828. If offline, operation continues to step 822.

In step 828, the special handling information can be retrieved from the control number database and a portion thereof can be applied to the mail piece. Operation continues to step 830, where the method ends.

In the case of offline printing, operation continued from step 820 to step 822.

In step 822, mail pieces in need of special handling can be sorted to one or more separate bins. The mail pieces may be sorted into one common bin for special handling services, or may be sorted into one or more bins according to the type of special handling service needed. Control continues to step 824.

In step 824, special handling information, such as address text, can be retrieved from the special handling table using the control number as a key or index value during another subsequent sorting process, for example, in batch processing of forwarded mail. For example, forwarding address text and forwarding type from the special handling table can be used in combination with sender's forwarding instruction from the mail piece table to determine text to print. This subsequent processing of the special handling mail can occur on the same or different equipment as the first sorting operation. Typically, the special handling mail will be processed on a transport capable of printing and applying address labels or other types of labels. Operation continues to step 826.

In step 826, the special handling information retrieved in step 824, or a portion thereof, can be applied (or printed) on the mail piece. Operation continues to step 830, where the method ends. It will be appreciated that the method of FIG. 8 may be repeated in whole or in part to complete a contemplated mail sorting task.

FIG. 9 is a block diagram of an exemplary embodiment of system for mail forwarding and special handling services with a control number database. In particular, FIG. 9 shows a mail piece sorting (or processing) system 900 that includes an imaging system 902, an external interface server 904, a workflow manager 906, a mail piece database server 908, a mail piece database 909, a video coding subsystem 910, an automatic recognition server 911, sorting/transport equipment 912 and printing/labeling equipment 914.

The imaging system 902 can include a video camera to capture still or moving images. In general, any now known or later developed imaging device capable of generating images suitable for automatic address recognition and/or video coding purposes may be used.

The imaging system 902 may be coupled or connected to a mail piece sorting system 903 that includes the sorting equipment 912 and, optionally, printing/labeling equipment 914. The printing labeling equipment can include equipment for printing/applying a mail piece identifier and also equipment for printing/applying a label to a mail piece, such as a change of address or forwarding label having a forwarding address printed thereon.

The external interface server 904 provides an interface between the mail piece sorting system 903 (and its associated subsystems and components) and the workflow manager 906.

The workflow manager 906 operates to coordinate the processing or sorting of mail pieces. For example, the workflow manager may received the mail piece images, store mail piece information in the mail piece database 909 via the mail piece database server 908, route mail piece images to the automatic recognition server 911 and/or video coding system 910 for address recognition; and communicate with the mail sorting system 903 regarding how to process and/or label a mail piece.

The mail piece database server 908 and the mail piece database 909 operate cooperatively to provide storage for information about particular mail pieces. The information may be stored and indexed according to a mail piece identification number that may be unique to each mail piece. The unique identification number may be applied to the mail piece in machine and/or human readable form, such as, for example, a single or multidimensional barcode, an RFID tag, or any known or later developed method suitable for identifying a mail piece. The mail piece information may include information generated during the mail piece processing; information received from another system or database, or include a combination of the above.

The video coding system 910 can include a traditional video coding system in which operators view a mail piece image, or portion thereof, and input a predetermined portion of an address into the system. The video coding process can be accomplished via a keyboard entry, a mouse or other pointing device selection, a voice input, a gesture input, a selection from a pick list, and/or the like.

The automatic recognition server 911 can include a processor for the automatic recognition of machine and/or handwritten text in a mail piece image.

The system 900 may be contained in a single system or distributed across multiple systems and/or processors. The components show in FIG. 9 can include hardware, software, mechanical subsystem, or a combination of the above. Also, the system 900 may be operated according to any of the methods for forwarding mail and/or providing special handling services as described above in conjunction with the description of any of FIGS. 1-8.

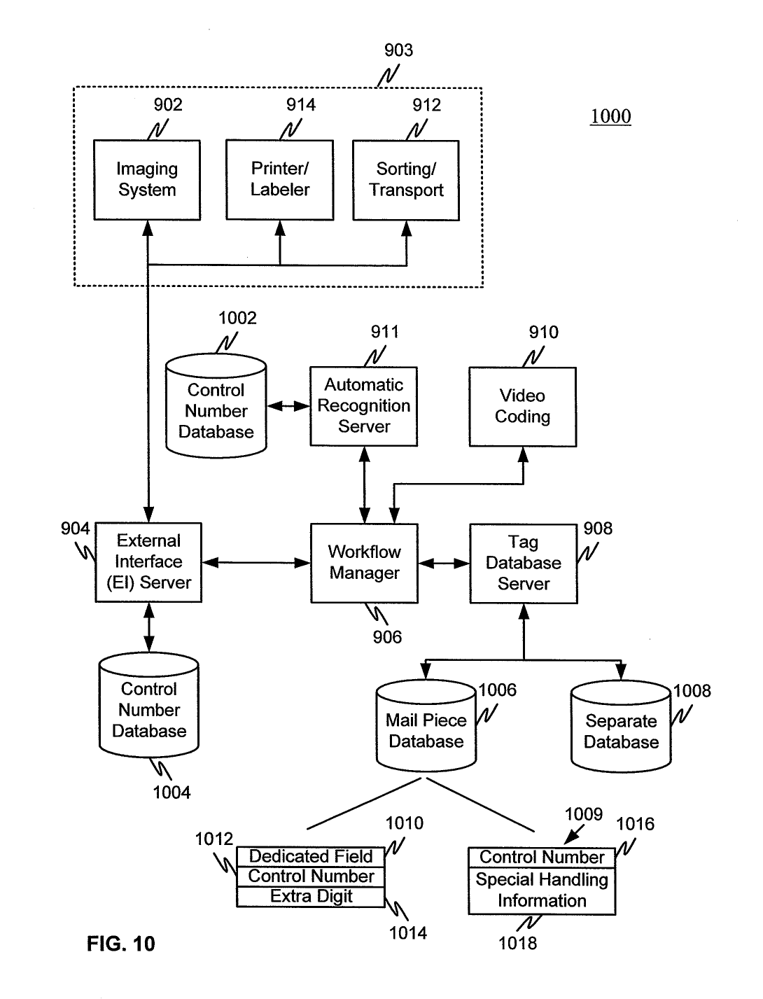

FIG. 10 is a block diagram of an exemplary embodiment of a system 1000 for mail forwarding and special handling services with a control number database. Components 902-914 have been described above. The system 1000 of FIG. 10 also includes a control number database 1002 and 1004, a sorting database 1006, and a separate sorting database 1008.

The control number database 1002 and 1004 may be coupled to a server different than the sorting database server 908, for example the control number database 1002 may be hosted in the automatic recognition server 911 or the control number database 1004 may be hosted in the external interface server 904. The control number database can include a control number field and one or more fields for storing special handling information, such as forwarding address text and forwarding type. One or more of the control number databases may be used and hosted on one or more servers within the system.

The sorting database 1006 can include a table having a dedicated field 1010, a control number field 1012, and/or an extras post code digit field 1014. The separate sorting database 1008 can include a table 1009 having a control number field 1016 and one or more special handling information fields 1018.

The system 1000 may be contained in a single system or distributed across multiple systems and/or processors. The components show in FIG. 10 can include hardware, software, mechanical subsystem, or a combination of the above. Also, the system 1000 may be operated according to any of the methods for forwarding mail and/or providing special handling services as described above in conjunction with the description of any of FIGS. 1-8.

It should be appreciated that the steps mentioned above may be performed on a single or distributed processor. Also, the processes, modules, and units described in the various figures of the embodiments above may be distributed across multiple computers or systems or may be co-located in a single processor or system.

Embodiments of the method, system and computer program product for mail forwarding and special handling services, may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic device such as a PLD, PLA, FPGA, PAL, or the like. In general, any process capable of implementing the functions or steps described herein can be used to implement embodiments of the method, system, or computer program product for mail forwarding and special handling services.

Furthermore, embodiments of the disclosed method, system, and computer program product for mail forwarding and special handling services may be readily implemented, fully or partially, in software using, for example, object or object-oriented software development environments that provide portable source code that can be used on a variety of computer platforms. Alternatively, embodiments of the disclosed method, system, and computer program product for mail forwarding and special handling services can be implemented partially or fully in hardware using, for example, standard logic circuits or a VLSI design. Other hardware or software can be used to implement embodiments depending on the speed and/or efficiency requirements of the systems, the particular function, and/or a particular software or hardware system, microprocessor, or microcomputer system being utilized. Embodiments of the method, system, and computer program product for mail forwarding and special handling services can be implemented in hardware and/or software using any known or later developed systems or structures, devices and/or software by those of ordinary skill in the applicable art from the functional description provided herein and with a general basic knowledge of the computer and mail sorting arts.

Moreover, embodiments of the disclosed method, system, and computer program product for mail forwarding and special handling services can be implemented in software executed on a programmed general-purpose computer, a special purpose computer, a microprocessor, or the like. Also, the mail forwarding and special handling services methods of this invention can be implemented as a program embedded on a personal computer such as a JAVA® or CGI script, as a resource residing on a server or graphics workstation, as a routine embedded in a dedicated processing system, or the like. The methods and systems can also be implemented by physically incorporating the method for mail forwarding and special handling services into a software and/or hardware system, such as the hardware and software systems of mail sorting or automatic address recognition system equipment.

It is, therefore, apparent that there is provided in accordance with the present invention, a method, system, and computer program product for mail forwarding and special handling services. While this invention has been described in conjunction with a number of embodiments, it is evident that many alternatives, modifications and variations would be or are apparent to those of ordinary skill in the applicable arts. Accordingly, applicants intend to embrace all such alternatives, modifications, equivalents and variations that are within the spirit and scope of this invention.

1. A method for sorting mail including:
reading an address on a mail piece during a first sorting operation, assigning a unique identification number to the mail piece, determining if the mail piece is in need of a special handling service (104), and storing information read from the mail piece and the unique identification number in a database indexed by mail piece identification number (108),
recording a first portion of special handling information in the database without recording an express notation that the mail piece is in need of the special handling service (108), and recording a second portion of the special handling information in a separate table of the database not indexed by the mail piece identification number (110);
sorting the mail piece to a separate bin, if the mail piece is in need of the special handling service (116); and
in a second sorting operation, different from the first sorting operation, processing mail pieces from the separate bin (118) and retrieving the special handling information corresponding to the mail piece from the database (120) and applying a portion of the special handling information to the mail piece (124).

2. The method of claim 1, wherein the special handling service is mail forwarding.

3. The method of claim 2, wherein the special handling information includes forwarding address text.

4. The method of claim 1, further comprising:
storing additional special handling information in a separate database, the separate database not indexed by mail piece identification number.

5. The method of claim 1, wherein the second sorting operation occurs on sorting equipment different than that used for the first sorting operation.

6. A mail processing system including:
recognizing means (911) for recognizing an address read from a scanned mail piece, means for assigning a unique identification number to the mail piece and for determining if the mail piece is in need of a special handling service, a database (909/1006) for storing information read from the mail piece, the database being indexed by mail piece identification number, and a printer (914) for applying special handling information to the mail piece if needed,
recording means (908) for recording special handling information in a separate table (1009) of the database not indexed by the mail piece identification number, without an express notation that the mail piece is in need of the special handling service;
sorting means (912) for sorting the mail piece to a separate bin, if the mail piece is in need of the special handling service;
processing means (906) for processing images from mail pieces in the separate bin, in a second sorting operation, different from the first sorting operation; and
retrieving means for retrieving the special handling information corresponding to the mail piece from the database and applying a portion of the special handling information to the mail piece via printing means (914).

7. The mail processing system of claim 6, wherein the recognizing means includes accepting input from a video coding operator (910).

8. The mail processing system of claim 6, wherein the special handling service is mail forwarding.

9. The mail processing system of claim 8, wherein the special handling information includes forwarding address text.

10. A method for sorting mail during a single sorting pass, the method including:
reading an address on a mail piece, assigning a unique identification number to the mail piece, determining if the mail piece is in need of a special handling service (204), and storing information read from the mail piece and the unique identification number in a database indexed by mail piece identification number (208),
recording special handling information in the database in a record corresponding to the mail piece identification number, without an express notation that the mail piece is in need of the special handling service (210); and
retrieving the special handling information corresponding to the mail piece from the database and applying the special handling information to the mail piece (214).

11. The method of claim 10, wherein the special handling service is mail forwarding.

12. The method of claim 11, wherein the special handling information includes forwarding address text.

13. A mail processing system for sorting mail during a single sorting pass, the system including:
recognizing means (911) for recognizing an address read from a scanned mail piece, means for assigning a unique identification number to the mail piece and means for determining if the mail piece is in need of a special handling service, a database (909/1006) for storing information read from the mail piece, the database being indexed by mail piece identification number, and a printer (914) for applying special handling information to the mail piece if needed,
recording means (908) for recording special handling information in the database in a record corresponding to the mail piece identification number, without an express notation that the mail piece is in need of the special handling service; and
retrieving means (906) for retrieving the special handling information corresponding to the mail piece identification number from the database and applying the special handling information to the mail piece.

14. The mail processing system of claim 13, wherein the recognizing means includes accepting input from a video coding operator (910).

15. The mail processing system of claim 13 or H, wherein the special handling service is mail forwarding.

16. The mail processing system of claim 15, wherein the special handling information includes forwarding address text.

17. A method for sorting mail including:
reading an address on a mail piece during a sorting pass, assigning a unique identification number to the mail piece, determining if the mail piece is in need of a special handling service (304), storing information read from the mail piece and the unique identification number in a database indexed by mail piece identification number (308),
recording special handling information in the database at the record corresponding to the mail piece identification number, without an express notation that the mail piece is in need of the special handling service (310);
if the mail piece is in need of the special handling service, printing and applying a scannable symbol to the mail piece indicating that the mail piece is in need of the special handling service (314); and
recognizing the scannable symbol on the mail piece (316) and retrieving the special handling information corresponding to the mail piece from the database (320/328) and applying a portion of the special handling information to the mail piece (322/330).

18. The method of claim 17, wherein the special handling service is mail forwarding.

19. The method of claim 18, wherein the special handling information includes forwarding address text.

20. The method of claim 17, wherein the scannable symbol is a barcode.

21. The method of claim 17, wherein the scannable symbol is a modified version of a routing barcode.

22. The method of claim 17, wherein the special handling information is applied to the mail piece during another sorting pass.

23-71. (canceled)
